(19) United States
(12) Patent Application Publication
(10) Pub. No.: US 2008/0211378 A1
(43) Pub. Date: Sep. 4, 2008

(54) Enhanced UV-Emitting Fluorescent Lamp

(76) Inventors: Arunava Dutta, Winchester, MA (US); Nicolas Desbiens, St.-Germain-Grantham (CA); Nathalie Camire, Drummondville (CA)

Correspondence Address: OSRAM SYLVANIA INC, 100 ENDICOTT STREET, DANVERS, MA, 01923, US

(21) Appl. No.: 12/017,078

(22) Filed: Jan. 21, 2008

Related U.S. Application Data
(63) Continuation-in-part of application No. 11/525,942, filed on Sep. 25, 2006.
(60) Provisional application No. 60/596,513, filed on Sep. 29, 2005.

(51) Int. Cl. H01J 1/62

(52) U.S. Cl. 313/486

(57) ABSTRACT

An enhanced UV-emitting fluorescent lamp is described that provides a UV spectral emission for simultaneously tanning of the human skin and promotion of vitamin D production in the human body. The lamp contains a phosphor layer having a phosphor blend of three rare-earth-activated phosphors: SrB₄O₇:Eu, LaPO₄:Ce and YPO₄:Ce. Preferably, the phosphor blend comprises 25-27% SrB₄O₇:Eu, 23-26% LaPO₄:Ce, and 47-52% YPO₄:Ce by weight.

### CROSS REFERENCE TO RELATED APPLICATIONS

This application is a continuation-in-part of U.S. application Ser. No. 11/525,942 filed Sep. 25, 2006, which claims the benefit of U.S. provisional application Ser. No. 60/596,513, filed Sep. 29, 2005.

### BACKGROUND OF THE INVENTION

Conventional fluorescent tanning lamps are basically low-pressure mercury discharge lamps that have a coating of at least one UV-emitting phosphor on the interior surface of the envelope. The typical geometry is a linear tubular shape though other shapes such as the spirals used in compact fluorescent lamps are also possible. The important lamp parameters for tanning purposes are generally 0 h UVA, 0 hTe and 100 h UVA maintenance. The 0 h UVA is the initial UVA flux produced by the lamp, 0 h Te is the initial erythemal time and 100 h UVA maintenance is the percentage of the initial UVA flux from the lamp that is available after 100 h of lamp operation. The maximum exposure time (Te) is calculated according to the method prescribed by the U.S. Food and Drug Administration. See, e.g., HHS Publication FDA 88-8234, “Quality Control Guide for Sunlamp Products,” (March 1988). The initial erythemal time, 0 h Te, is the value of Te calculated for the initial operation of the lamp after a brief period of stabilization.

Tanning lamps in the market today are designed exclusively for tanning which is not surprising. However, UV radiation is also able to help the human body produce vitamin D. It would therefore be advantageous to create a UV-emitting light source that would both tan and promote vitamin D synthesis in the human body. For example, this could benefit people who for a number of different reasons are unable to go out in the sunlight to promote vitamin D synthesis in the body or it might also be an attractive alternative for people who cannot process vitamin D enhanced food.

### SUMMARY OF THE INVENTION

It is an object of the invention to obviate the disadvantages of the prior art.

It is a further object of the invention to provide a lamp that will perform adequately both as a tanning lamp and as a vitamin D enhancing lamp.

In accordance with one objection of the invention, there is provided a UV-emitting lamp containing a UV-emitting phosphor blend wherein the lamp when operating exhibits a vitamin D ratio of 1.5 to 2, a Hpi:Her ratio of 0.85 to 1, and a 0 h Te of 30 to 40 minutes and the phosphor blend contains a SrB₄O₇:Eu phosphor, a LaPO₄:Ce phosphor and a YPO₄:Ce phosphor wherein the sum of the weight percentages of the phosphors in the blend is 100%.

In a preferred embodiment, the phosphor blend comprises 25-27% SrB₄O₇:Eu, 23-26% LaPO₄:Ce, and 47-52% YPO₄:Ce by weight.

### BRIEF DESCRIPTION OF THE DRAWINGS

FIG. 1 shows the Vitamin D CIE 2006, Immediate Pigmentation and IEC Total Erythemal Effectiveness response functions.

FIG. 2 is a simplex centroid design for a three-component blend of SrB₄O₇:Eu, LaPO₄:Ce and YPO₄:Ce phosphors.

FIG. 3 is a plot the dependence of 0 h UVA within the phosphor blend composition space illustrated in FIG. 2.

FIG. 4 is a plot of the dependence of 0 h Te within the phosphor blend composition space illustrated in FIG. 2.

FIG. 5 is a plot of the dependence of the 100 h UVA maintenance within the phosphor blend composition space illustrated in FIG. 2.

FIG. 6 is a plot of the dependence of the vitamin D ratio within the phosphor blend composition space illustrated in FIG. 2.

FIG. 7 is a plot of the dependence of the Hpi:Her ratio within the phosphor blend composition space illustrated in FIG. 2.

FIG. 8 shows the region of the phosphor blend composition space that is able to simultaneously satisfy a vitamin D ratio of 1.5 to 2, a Hpi:Her ratio of 0.85 to 1, and a 0 h Te of 30 to 40 minutes.

FIG. 9 is an illustration of a longitudinal cross section of a reflector tanning lamp.

FIG. 10 is an illustration of a perpendicular cross section of a reflector tanning lamp.

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

The vitamin D enhancing ability of a lamp is determined by the vitamin D ratio which is defined as the ratio of the vitamin D CIE 2006 Flux (W/m²) to the Total IEC Erythemal Effective Irradiance (W/m²). The target vitamin D ratio that is desired is in the range of 1.5-2. For adequate tanning ability, this lamp must simultaneously have a suitable value for a second response called the Hpi:Her ratio. This is defined as a numerical factor (0.0025) times the ratio of the Immediate Pigmentation Flux (W/m²) to the Total IEC Erythemal Effective Irradiance (W/m²). The target Hpi:Her ratio is 0.85-1. Finally, this lamp must at the same time have a suitable value for 0 h Te (the initial erythemal time) response which is desired to be in the range of 30-40 minutes.

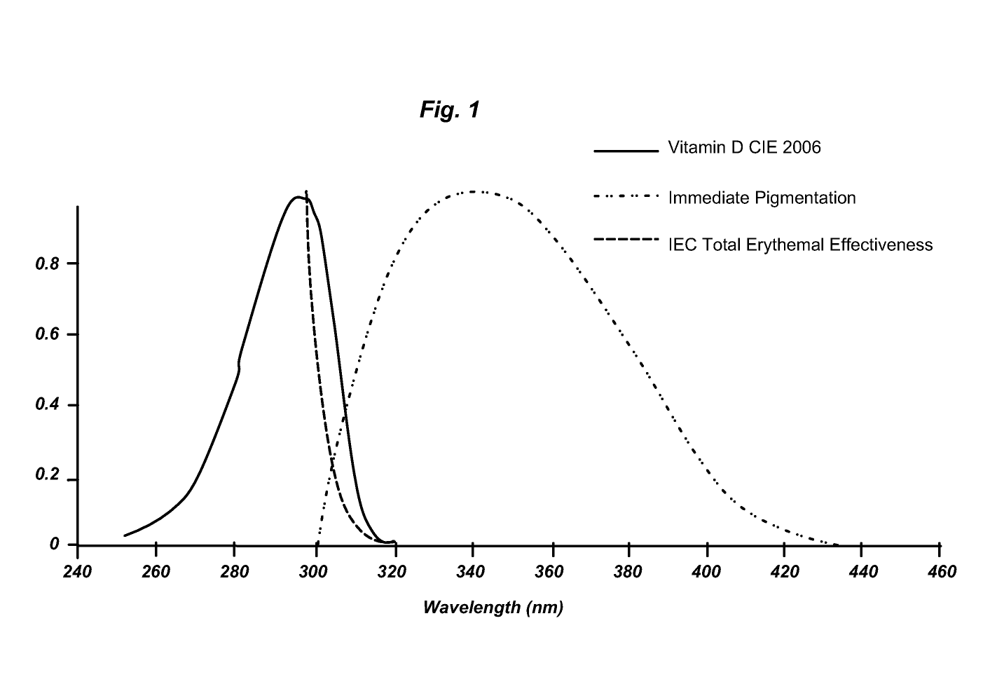

FIG. 1 shows the three response functions of interest: Vitamin D CIE 2006, Immediate Pigmentation and IEC Total Erythemal Effectiveness. Each one shows the dependence of the particular response on wavelength. It is clear that each response depends quite differently on wavelength of the radiation emitted by the lamp. To obtain the flux for any response, the vitamin D CIE 2006 flux for example, the response function (in this case the vitamin D response function) has to be weighted by the lamp spectral power distribution (SPD). It also follows from the different response functions that while a lamp may have good tanning ability it may have a poor vitamin D ratio and vice versa.

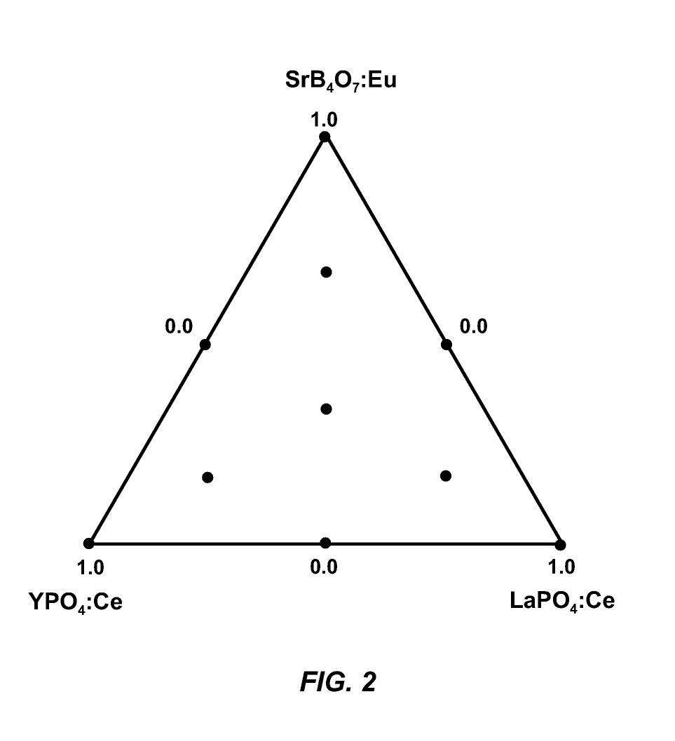

Three rare-earth-activated UV-emitting phosphors were selected for making tanning lamps. SrB₄O₇:Eu, LaPO₄:Ce and YPO₄:Ce. The SrB₄O₇:Eu phosphor has a peak emission at about 366 nm. The LaPO₄:Ce phosphor has a bimodal emission at about 316 nm and 338 nm. The YPO₄:Ce phosphor also has a bimodal emission at about 338 nm and 356 nm. A simplex centroid design was made to create ten different blends that have one or more of these phosphors. This design is shown in FIG. 2.

In FIG. 2, the three vertices of the triangle represent pure components, the three mid points on the sides of the triangle represent a two-component 50:50 blend of the phosphors at the end vertices, and the four points inside the triangle are three-component blends of the phosphors. The point located at the center of the triangle is the centroid or a blend with equal proportions of all three phosphors. The other three points represent blends having a ⅔, ⅙, ⅙ composition, where the component vertex closest to the point comprises the ⅔ fraction of the blend and the component vertices further away each comprise a ⅙ fraction. All of the blend proportions and percentages described herein are based on the weights of the individual phosphor components unless otherwise indicated.

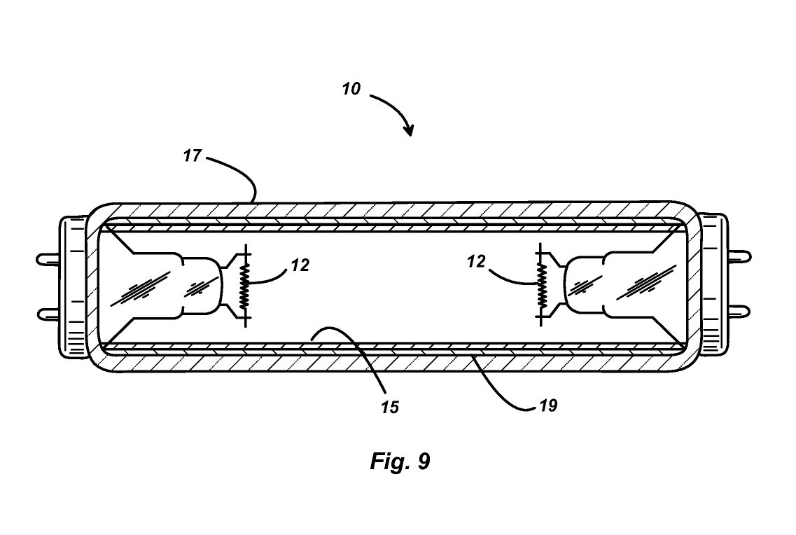

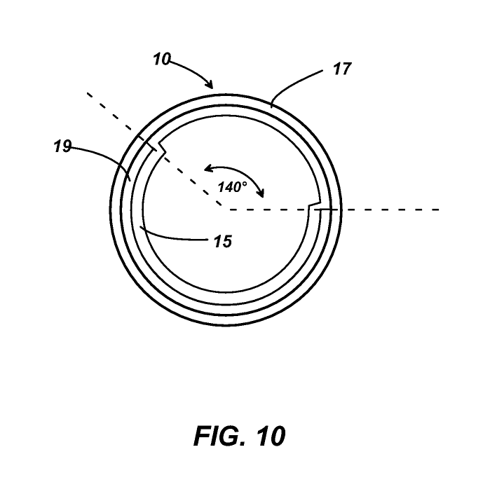

Reflector lamps (similar to that illustrated in FIGS. 9 and 10) were made that had been coated with each of the ten different phosphor blends. Ten lamps of each of the ten blends were photometered for 0 h UVA, 0 h Te and 100 h UVA maintenance. In addition, the spectral power distributions for these lamps were measured and the response functions shown in FIG. 1 used to determine the vitamin D ratio and Hpi:Her ratio for all ten phosphor blends.

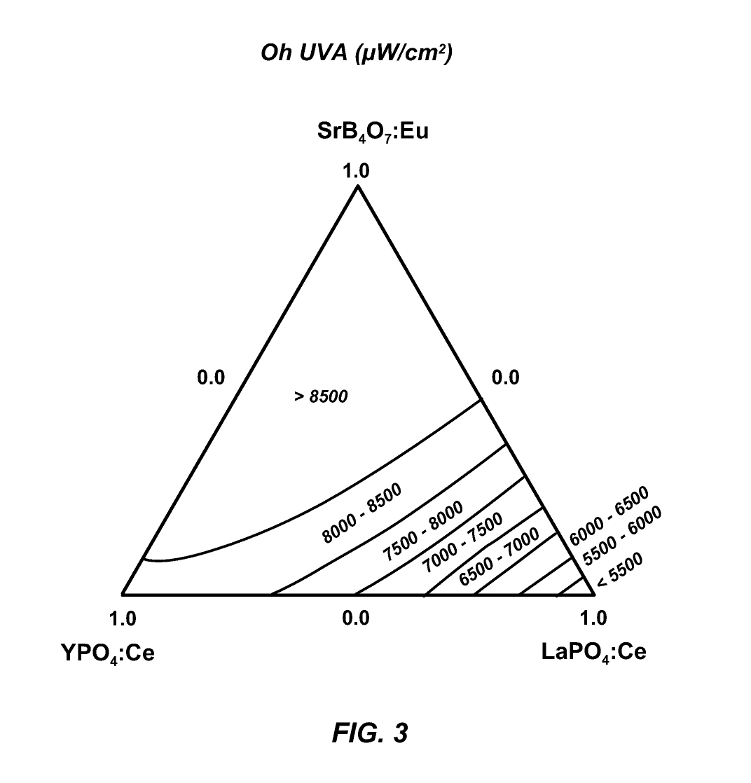

FIG. 3 below shows the dependence of 0 h UVA on the phosphor blend composition. It is seen that blend compositions rich in the SrB₄O₇:Eu phosphor result in higher 0 h UVA while blend compositions rich in LaPO₄:Ce phosphor result in lower values of 0 h UVA. It is desirable to have a value of 0 h UVA that is >8000 μW/cm².

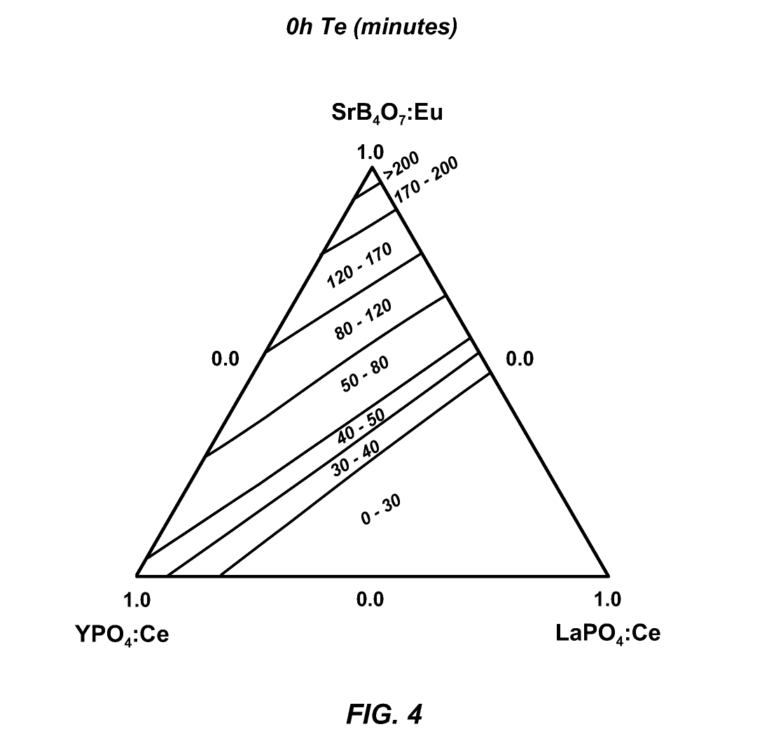

The dependence of 0 h Te on phosphor blend composition is shown in FIG. 4. It is clear from FIG. 4 that higher levels of LaPO₄:Ce in the blend results in faster (shorter) 0 h Te for the lamp while increasing the percentage of SrB₄O₇:Eu in the blend results in a slower (longer) 0 h Te. The phosphor blend region that would give a lamp 0 h Te in the preferred 30-40 minute range is identified in FIG. 4.

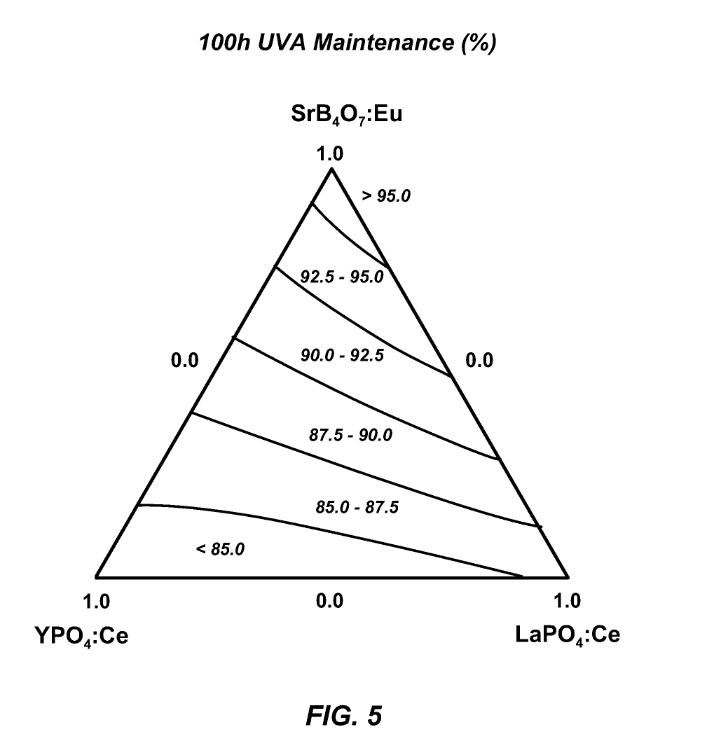

The 100 h UVA maintenance of the lamps is shown in FIG. 5. While the maintenance is generally good, >85%, for any composition involving these three phosphors, it is seen that increasing the level of the SrB₄O₇:Eu phosphor in the blend relative to the phosphate phosphors increases the 100 h UVA maintenance further.

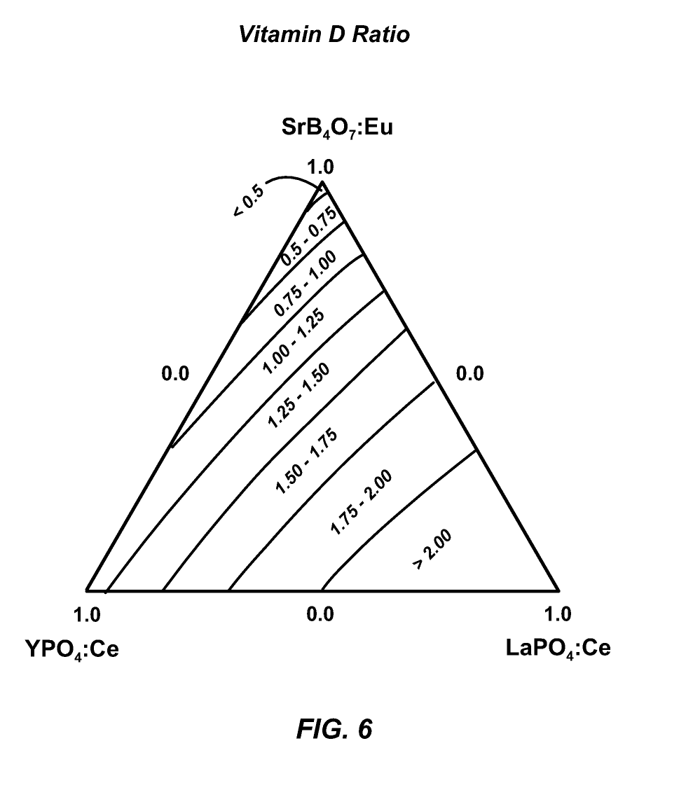

The vitamin D ratio for all ten different phosphor blends is determined from the response functions shown in FIG. 1 and the lamp SPD for each of the ten blends. The dependence of the vitamin D ratio on the phosphor blend composition is shown in FIG. 6. It is observed from FIG. 6 that the higher the level of LaPO₄:Ce phosphor in the blend the higher the vitamin D ratio. In other words moving towards the LaPO₄:Ce vertex in the triangle increases the vitamin D ratio whereas moving towards the SrB₄O₇:Eu vertex lowers the vitamin D ratio. The particular phosphor blend space that allows the desired vitamin D ratio of >1.5 is also shown in FIG. 6.

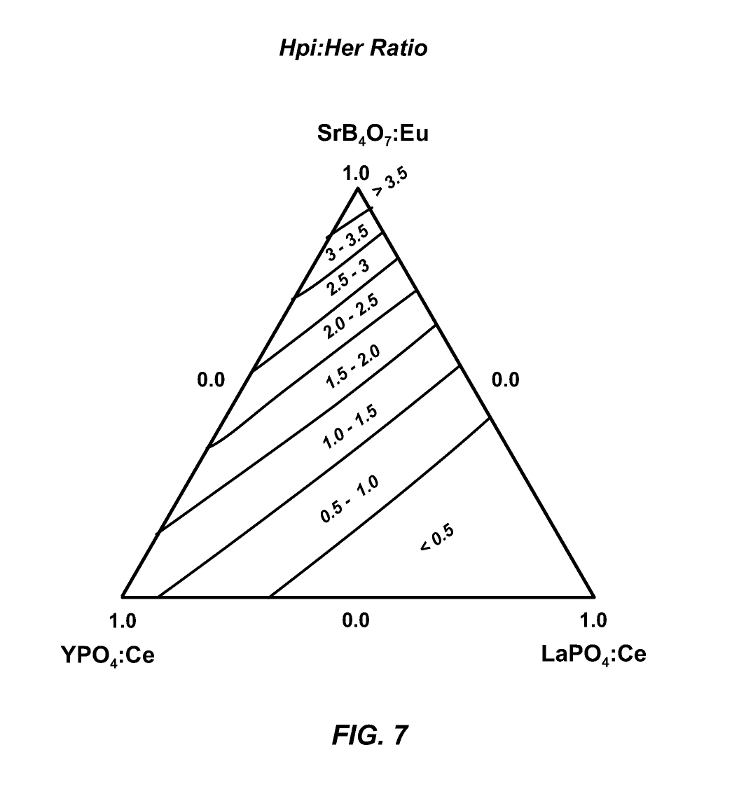

The Hpi:Her ratio was also determined from the response functions shown in FIG. 1 and the SPD of the lamps for all ten different phosphor blends. The dependence of the Hpi:Her ratio on phosphor blend composition is shown in FIG. 7. As described above, the Hpi:Her ratio is defined as a numerical factor (0.0025) times the ratio of the Immediate Pigmentation Flux (W/m²) to the Total IEC Erythemal Effective Irradiance (W/m²). The target Hpi:Her ratio is 0.85-1 for adequate tanning ability.

It is clear from FIG. 7 that higher values of Hpi:Her are obtained by moving towards the SrB₄O₇:Eu vertex. Yet FIG. 6 indicates that for higher values of the vitamin D ratio one must travel in the other direction towards the LaPO₄:Ce vertex. Also for suitable values of 0 h Te, it would be preferred from FIG. 4 not to have high levels of SrB₄O₇:Eu phosphor in the blend.

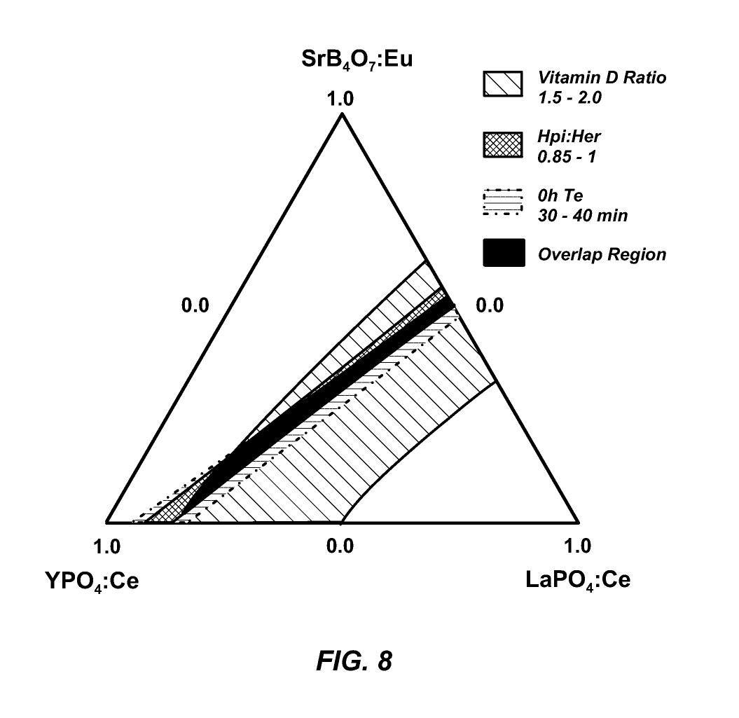

Using the data shown in FIGS. 4, 6, and 7 there is a small region of the phosphor blend composition space that is able to satisfy all three desired criteria simultaneously: a vitamin D ratio of 1.5 to 2, a Hpi:Her ratio of 0.85 to 1, and a 0 h Te of 30 to 40 minutes. This overlap region is shown in FIG. 8. Preferably, the phosphor blend comprises 25-27% SrB₄O₇:Eu, 23-26% LaPO₄:Ce, and 47-52% YPO₄:Ce by weight.

A blend was selected from this narrow region and used to make reflector lamps. The blend was 25.3% SrB₄O₇:Eu, 25.4% LaPO₄:Ce and 49.3% YPO₄:Ce. The properties of the finished lamps are shown below in Table 1:

TABLE 1

| | |
|---|---|
| Vitamin D ratio | 1.7 |
| Hpi:Her ratio | 0.85 |
| 0 h Te | 34 minutes |
| 0 h UVA | 8170 μW/cm² |
| 100 h UV maintenance | 87% |

Deviation from this particular blend by more than 2 percentage points in the direction of increasing the amount SrB₄O₇:Eu phosphor will cause the vitamin D ratio to drop below the desirable target level. The result will be a lamp that will tan but will not be effective for vitamin D production.

An illustration of a typical reflector tanning lamp is shown in FIGS. 9 and 10. FIG. 9 illustrates a longitudinal cross section through the tubular lamp along its central axis. FIG. 10 illustrates a cross section perpendicular to the central axis of the lamp. The lamp 10 has a hermetically sealed UV transmissive, glass envelope 17. The interior of the envelope 17 is filled with an inert gas such as argon, neon, krypton or a mixture thereof, and a small quantity of mercury, at least enough to provide a low vapor pressure during operation. An electrical discharge is generated between electrodes 12 to excite the mercury vapor to generate ultraviolet radiation. A coating of a UV reflective material 19, e.g., aluminum oxide (alumina), is coated on the interior surface of the envelope 17 and a phosphor layer 15 is applied over the reflective layer 19. For a lamp according to this invention, the phosphor layer 15 contain the blend of the three phosphors, SrB₄O₇:Eu, LaPO₄:Ce and YPO₄:Ce. While the phosphor layer 15 covers the entire bulb circumference, a typical coverage angle for the reflector layer varies from 180° to 240° of the circumference. A reflector layer that covers 220° of the circumference is shown in FIG. 10. The primary role of the reflector material is to reflect the UV radiation emitted by the phosphor layer back towards the front of the lamp from where it escapes through the region of the bulb that does not have any UV reflective material on the glass.

While there have been shown and described what are at present considered to be preferred embodiments of the invention, it will be apparent to those skilled in the art that various changes and modifications can be made herein without departing from the scope of the invention as defined by the appended claims.

We claim:

1. A UV-emitting fluorescent lamp, comprising:
a sealed tubular envelope and at least one electrode for generating a discharge, the envelope containing an amount of mercury and having a phosphor layer on an interior surface;
the phosphor layer containing a phosphor blend comprising a mixture of a SrB₄O₇:Eu phosphor, a LaPO₄:Ce phosphor and a YPO₄:Ce phosphor wherein the sum of the weight percentages of the phosphors in the blend is 100%; and
the lamp when operating exhibiting a vitamin D ratio of 1.5 to 2, a Hpi:Her ratio of 0.85 to 1, and a 0 h Te of 30 to 40 minutes.

2. The lamp of claim 1 wherein the phosphor blend comprises 25-27% SrB₄O₇:Eu, 23-26% LaPO₄:Ce, and 47-52% YPO₄:Ce by weight.

3. The lamp of claim 1 wherein the phosphor blend comprises 25.3% SrB₄O₇:Eu, 25.4% LaPO₄:Ce and 49.3% YPO₄:Ce by weight.

4. The lamp of claim 1 wherein the lamp has a 0 h UVA of >8000 μW/cm².

5. The lamp of claim 1 wherein the lamp has a 100 h UVA maintenance of >85%.

6. The lamp of claim 1 wherein the lamp has a UV-reflective layer disposed between the phosphor layer and the envelope, the UV-reflective layer extending partially around the circumference of the envelope and comprising aluminum oxide.

7. The lamp of claim 6 wherein the UV-reflective layer extends from 180° to 240° around the circumference.

8. The lamp of claim 6 wherein the UV-reflective layer extends from 220° around the circumference.

9. A UV-emitting fluorescent lamp, comprising:
a sealed tubular envelope and at least one electrode for generating a discharge, the envelope containing an amount of mercury and having a phosphor layer on an interior surface;
the phosphor layer containing a phosphor blend comprising 25-27% of a SrB₄O₇:Eu phosphor, 23-26% of a LaPO₄:Ce phosphor, and 47-52% of a YPO₄:Ce phosphor by weight wherein the sum of the weight percentages of the phosphors in the blend is 100%.

10. The lamp of claim 9 wherein the phosphor blend comprises 25.3% SrB₄O₇:Eu, 25.4% LaPO₄:Ce and 49.3% YPO₄:Ce by weight.

11. The lamp of claim 9 wherein the lamp has a 0 h UVA of >8000 μW/cm².

12. The lamp of claim 9 wherein the lamp has a 100 h UVA maintenance of >85%.

13. The lamp of claim 9 wherein the lamp has a UV-reflective layer disposed between the phosphor layer and the envelope, the UV-reflective layer extending partially around the circumference of the envelope and comprising aluminum oxide.

14. The lamp of claim 13 wherein the UV-reflective layer extends from 180° to 240° around the circumference.

15. The lamp of claim 13 wherein the UV-reflective layer extends from 220° around the circumference.
